(19) United States
(12) Patent Application Publication
(10) Pub. No.: US 2013/0173931 A1
(43) Pub. Date: Jul. 4, 2013

(54) Host Device and Method for Partitioning Attributes in a Storage Device

(71) Applicant: Yonatan Tzafrir, (US)

(72) Inventor: Yonatan Tzafrir, (US)

(21) Appl. No.: 13/341,649

(22) Filed: Dec. 30, 2011

(51) Int. Cl. G06F 12/14; G06F 21/00

(52) U.S. Cl. 713/193

(57) ABSTRACT

A host device and method for partitioning attributes in a storage device are provided. In one embodiment, a host device is provided that is in communication with a storage device storing a table associating logical address ranges with an encryption key and read/write permissions. The host device sends a request to the storage device to add a column to the table and then sends a request to the storage device to add an attribute to a cell of the added column to the table associated with a particular logical address range. The table and commands can be those compatible with the Trusted Computing Group's (TCG's) Opal standard.

### BACKGROUND

The Trusted Computing Group (TCG) has promulgated standards specifying minimum acceptable capabilities of a storage device in specific classes, referred to as Security Subsystem Classes (SSCs). One of those standards, referred to as the TCG Storage SSC Opal standard, defines the specifications and methodologies for fixed media storage devices in consumer and enterprise storage systems, such as notebooks and desktops. The TCG Opal standard is based on the Trusted Storage Architecture Core Specification Version 1.0 Revision 1.0 and provides secure boot capability (pre-boot authentication), as well as protection of user data from compromise due to the loss, theft, repurposing, or end of life of the storage device. The TCG Opal standard also provides administrative capabilities that allow administrative functions such as user enrollment and media management. In general, the TCG Opal standard supports sectioning a storage device into multiple storage ranges (i.e., logical block address (LBA) ranges) with each having its own authentication and encryption key and access control. The range start, range length, read/write locks, and the user read/write access control for each range are configurable by an administrator. This helps handle security breaches involving lost or stolen storage devices.

### Overview

Embodiments of the present invention are defined by the claims, and nothing in this section should be taken as a limitation on those claims.

By way of introduction, the below embodiments relate to a host device and method for partitioning attributes in a storage device. In one embodiment, a host device is provided that is in communication with a storage device storing a table associating logical address ranges with an encryption key and read/write permissions. The host device sends a request to the storage device to add a column to the table and then sends a request to the storage device to add an attribute to a cell of the added column to the table associated with a particular logical address range. The table and commands can be those compatible with the Trusted Computing Group's (TCG's) Opal standard.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary host device and storage device of an embodiment.

FIG. 2 is an attribute table of an embodiment.

FIG. 3 is an attribute table of an embodiment where attributes are specified by a pointer.

FIG. 4 is a pre-configuration table from the Trusted Computing Group (TCG) Opal standard.

FIG. 5 is a locking table from the Trusted Computing Group (TCG) Opal standard in which an attribute column has been added using a method of an embodiment.

FIG. 6 is an illustration of a communication packet of an embodiment.

FIG. 7 is a flow diagram of an embodiment for specifying attributes for address ranges.

### DETAILED DESCRIPTION OF THE PRESENT PREFERRED EMBODIMENTS

Exemplary Host and Storage Devices

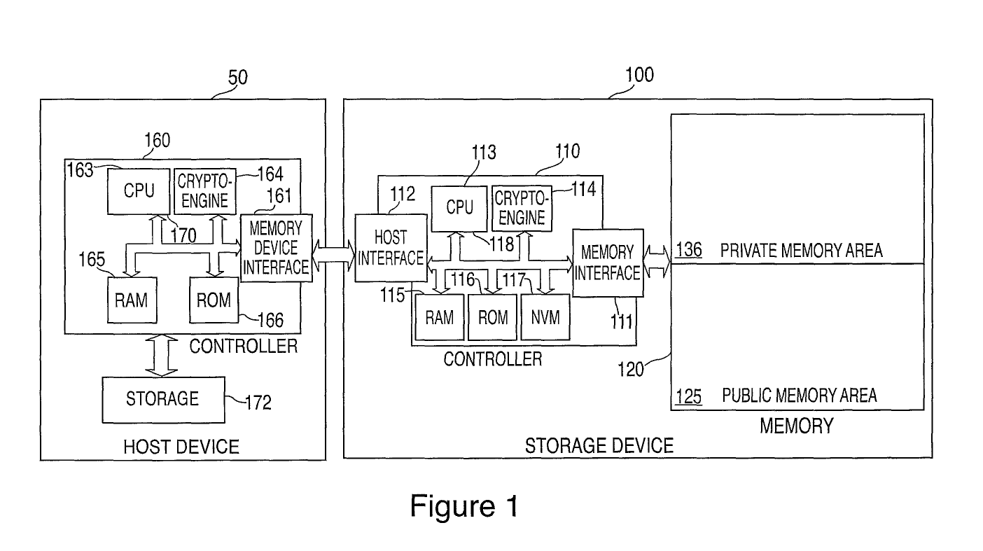

Turning now to the drawings, FIG. 1 is a block diagram of a host device 50 in communication with a storage device 100 of an embodiment. As used herein, the phrase “in communication with” could mean directly in communication with or indirectly in communication with through one or more components, which may or may not be shown or described herein. For example, the host device 50 and storage device 100 can each have mating physical connectors that allow the storage device 100 to be removably connected to the host device 50. The host device 50 can take any suitable form, such as, but not limited to, a mobile phone, a digital media player, a game device, a personal digital assistant (PDA), a personal computer (PC), a kiosk, a set-top box, a TV system, a book reader, or any combination thereof. In this embodiment, the storage device 100 is a mass storage device that can take any suitable form, such as, but not limited to, an embedded memory (e.g., a secure module embedded in the host device 50) and a handheld, removable memory card (e.g., a Secure Digital (SD) card, or a MultiMedia Card (MMC)), as well as a universal serial bus (USB) device and a removable or non-removable hard drive (e.g., magnetic disk or solid-state or hybrid drive). In one embodiment, the storage device 100 takes the form of an iNAND™ eSD/eMMC embedded flash drive by SanDisk Corporation.

As shown in FIG. 1, the storage device 100 comprises a controller 110 and a memory 120. The controller 110 comprises a memory interface 111 for interfacing with the memory 120 and a host interface 112 for interfacing with the host 50. The controller 110 also comprises a central processing unit (CPU) 113, a hardware crypto-engine 114 operative to provide encryption and/or decryption operations, read access memory (RAM) 115, read only memory (ROM) 116 which can store firmware for the basic operations of the storage device 100, and a non-volatile memory (NVM) 117 which can store a device-specific key used for encryption/decryption operations. The controller 110 can be implemented in any suitable manner. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Examples of controllers include, but are not limited to, the following microcontrollers: ARC 625D, Atmel AT91SAM, Microchip PIC18F26K20, and Silicon Labs C8051F320.

The memory 120 can take any suitable form. In one embodiment, the memory 120 takes the form of a solid-state (e.g., flash) memory and can be one-time programmable, few-time programmable, or many-time programmable. However, other forms of memory, such as optical memory and magnetic memory, can be used. In this embodiment, the memory 120 comprises a public memory area 125 that is managed by a file system on the host 50 and a private memory area 136 that is internally managed by the controller 110. The private memory area 136 can store a shadow master boot record (MBR) (as will be described below), as well as other data, including, but not limited to, content encryption keys (CEKs) and firmware (FW) code. However, access to the various elements in the private memory area 136 can vary. The public memory area 125 and the private memory area 136 can be different partitions of the same memory unit or can be different memory units. The private memory area 136 is “private” (or “hidden”) because it is internally managed by the controller 110 (and not by the host's controller 160).

Turning now to the host 50, the host 50 comprises a controller 160 that has a storage device interface 161 for interfacing with the storage device 100. The controller 160 also comprises a central processing unit (CPU) 163, an optional crypto-engine 164 operative to provide encryption and/or decryption operations, read access memory (RAM) 165, read only memory (ROM) 166, a security module 171, and storage 172. The storage device 100 and the host 150 communicate with each other via a storage device interface 161 and a host interface 112. For operations that involve the secure transfer of data, it is preferred that the crypto-engines 114, 164 in the storage device 100 and host 150 be used to mutually authenticate each other and provide a key exchange. After mutual authentication is complete, it is preferred that a session key be used to establish a secure channel for communication between the storage device 150 and host 100. Alternatively, crypto-functionality may not be present on the host side, where authentication is done only using a password. In this case, the user types his password into the host device 50, and the host device 50 sends it to the storage device 100, which allow access to the public memory area 125. The host 50 can contain other components (e.g., a display device, a speaker, a headphone jack, a video output connection, etc.), which are not shown in FIG. 1 to simplify the drawings.

Embodiments Relating to Partitioning Attributes

The storage device 100 can be used with the host device 50 in many consumer environments. As mentioned above, the storage device 100 can be embedded in the host device 50 or removably connected with the host device 50, such as when the storage device takes the form of a removable memory card or an SSD drive. The increase in storage density of non-volatile storage devices allows for an ever-growing number of host applications to make use of the additional storage space. For example, the additional storage may be utilized for MP3 audio files, high-resolution images files, video files, and documents. A variety of host applications may therefore share access to the non-volatile storage device and access data or store and manage their own data. While each application may share the overall quantity of storage space in a non-volatile storage device, the bandwidth, power consumption, and file security requirements and other attributes of each application may differ. In order to address these issues, these embodiments can be used to apply different characteristics to different address ranges of non-volatile memory 120 in the storage device 100.

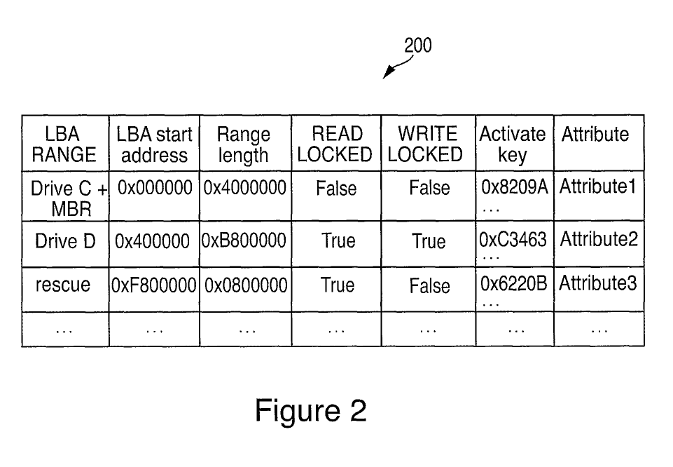

The correlation between logical ranges and characteristics to be applied can be stored in any suitable manner in the storage device 100. In general, it is preferred that the correlation be stored in an area of the storage device 100 that is not accessible to an end user in order to prevent unauthorized tampering of the data. For example, the correlation can be stored in the private memory area 136 or the non-volatile memory 117 of the controller 110. The correlation can be presented in any suitable form. For example, in one embodiment, the correlation is stored in a hierarchical tree structure. In another embodiment, the correlation is stored in a table 200, such as the one shown in FIG. 2. As shown in FIG. 2, this table 200 stores an LBA range, specified by an LBA start address and a range length. For each LBA range, the table 200 also specifies whether the range can be read (“read locked”) or written to (“write locked”), as well as the encryption key used for the range (“activate key”). Although the activate key column is shown having specific key values stored in its cells, the cells can instead store a pointer to a memory location that stores the key values. This table 200 also has an “attribute” column. As used herein, the term “attribute” can refer to any suitable attribute, such as, but not limited to, attributes pertaining to single-level cells (SLC) or multi-level cells (MLC) characteristics, power consumption, bandwidth consumption, high\low data retention, high\low endurance, slow\fast random writes range, high\low latency, and high reliability for power failures. As shown in the table 200 in FIG. 2, in one embodiment, attributes are different from read/write permissions and from encryption keys.

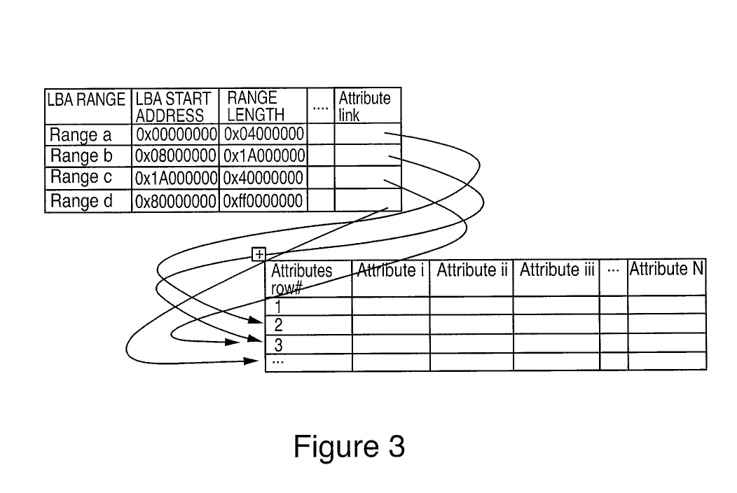

It should be noted that the table 200 shown in FIG. 2 is merely an example, and other formats can be used. For example, as shown in FIG. 3, instead of the attribute(s) being specified in the cells of the table, the cells can instead contain a pointer to a data structure containing the attribute(s). That way, over time, as the attribute(s) are changed, a change can be made to the data structure rather than to the cells of the table.

In operation, the controller 110 of the storage device 100 receives a read, write, erase, or modify data request from the host device 50. The received request may include an address, or the address may be inferred or calculated based on a previously-received request. In one embodiment, the address is a logical block address (LBA), which may be remapped by the controller 110 to a physical storage location in the non-volatile memory 120. The controller 110 then consults the table 200 to determine if the address for the request is within one or more of the specified ranges, or logical partitions, of the memory 120. If the address is specified in the table, the various characteristics are applied. For example, with reference to FIG. 2, if the request is for Drive C, the user can read or write into the partition (because the “read locked” and “write locked” fields are negative) using the encryption key and attributes (e.g., a SLC write or an MLC write) specified by the table 200. If the address is not specified in the table, a default characteristic can be applied. It should be noted that attributes can be for sector (LBA) range or for a dedicated partition, or part of the partition, depending on the attribute capabilities.

While attributes can be stored in any suitable way, one embodiment takes advantage of the partitioning that is already set forth in Trusted Computing Group's (TCG's) Storage SSC Opal standard. In general, the TCG Opal standard supports sectioning a storage device into multiple storage ranges (i.e., logical block address (LBA) ranges) with each having its own authentication and encryption key and access control. As the TCG Opal table already contains an LBA range start, range length, read/write locks, and the user read/write access control for each range, modifying the table to also include the attribute(s) associate with an LBA range would be a convenient addition. That is, these embodiments take advantage of the fact that the existing TCG Opal security protocol already supports the sectioning of a storage device for different LBA ranges and for supporting SSD performance and functionality attributes. Further, the TCG Opal standard is a relatively simple mechanism that uses only two higher level protocol command to communicate and is implemented today by most SSD vendors.

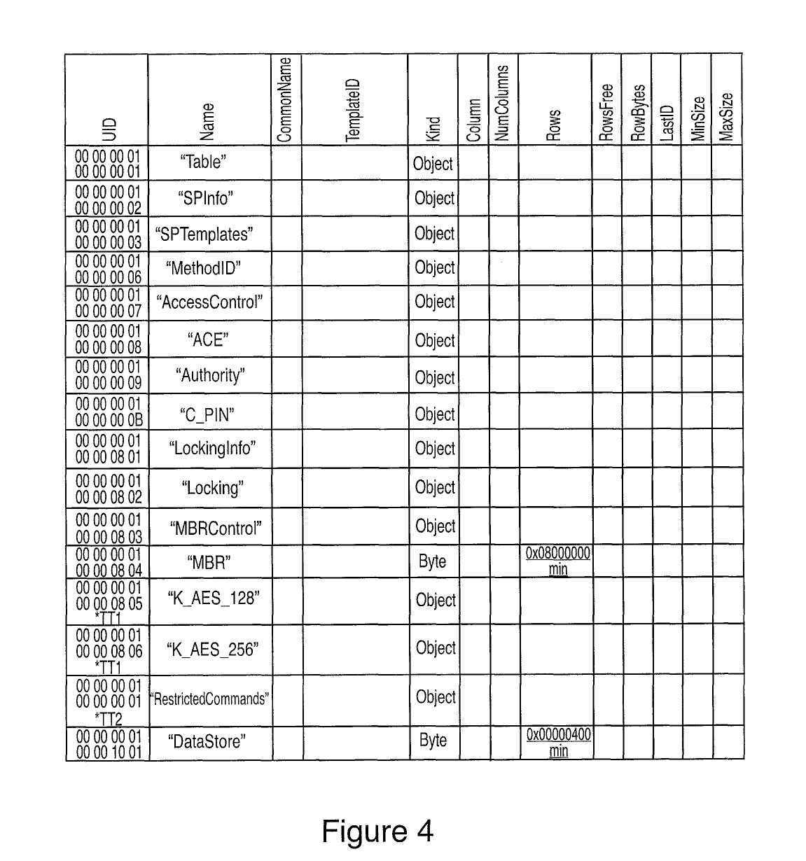

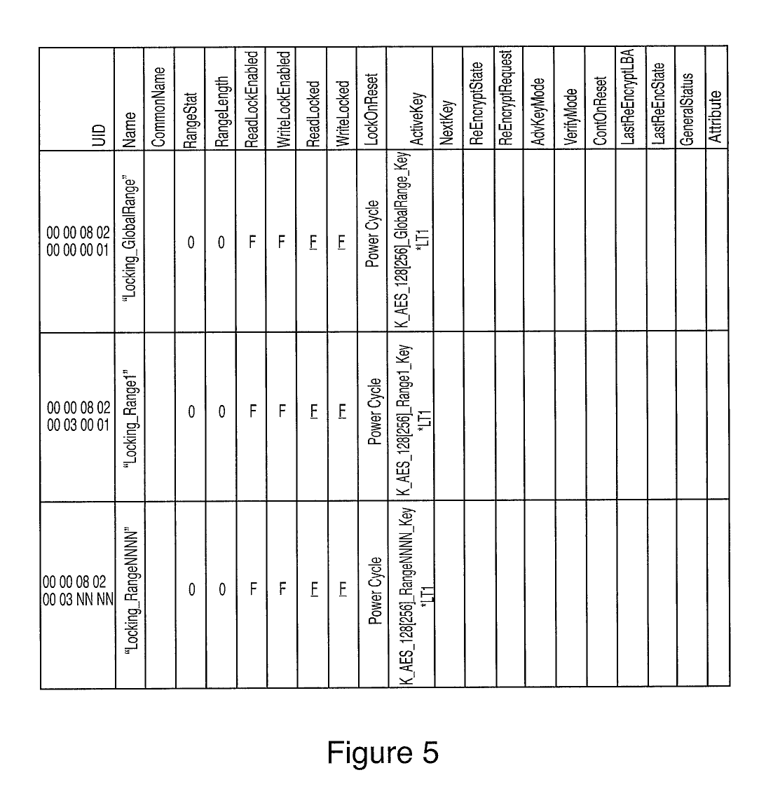

In one embodiment, a column dedicated to attributes is added to the TCG Opal “Locking SP table.” FIG. 4 is an illustration of a pre-configuration table of the TCG Opal Locking SP table. This table is a replication of Table 22 in the TCG Opal specification 1.00, revision 3.03, published Dec. 18, 2009, the entirety of which is incorporated herein by reference. This pre-configuration table allows an administrator to add to the number of columns in the Locking SP table. In this example, this would be done by increasing the “NumColumns” column of the “Locking” row by one. The resulting Locking SP table is shown in FIG. 5, which is a modification of Table 29 in the TCG Opal specification 1.00, revision 3.03, published Dec. 18, 2009.

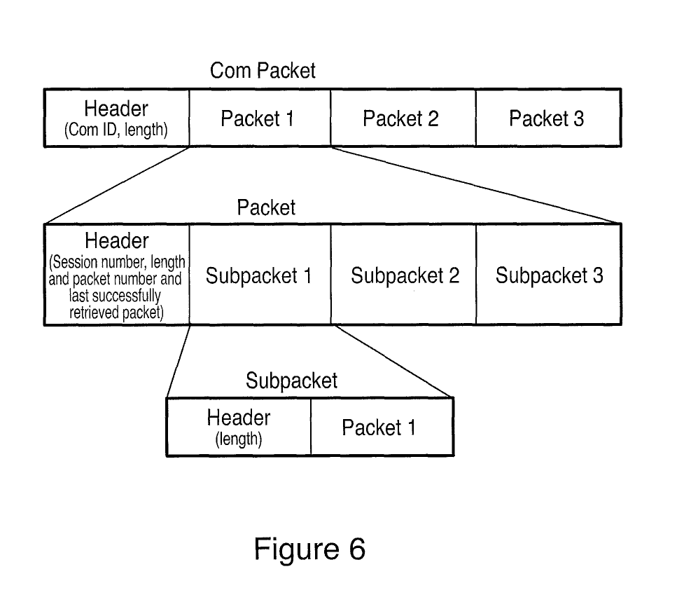

With the added column now added to the Locking SP table, the relevant attribute(s) can be added to the cells in the column for the relevant address ranges. To do this, a TCG “set” command can be used to program the cells. (A TCG “get” command can be used to read the cells.) Such a command can be a sub-command within one or two Serial Advanced Technology Attachment (SATA) or Peripheral Component Interconnect (PCI) commands, as shown in FIG. 6. SATA usually has two security commands, and the command structure shown in FIG. 6 is a lower-level SATA commands. The attribute written to the added column of the Locking SP table can be located in the “Packet 1” field of the “Subpacket.”

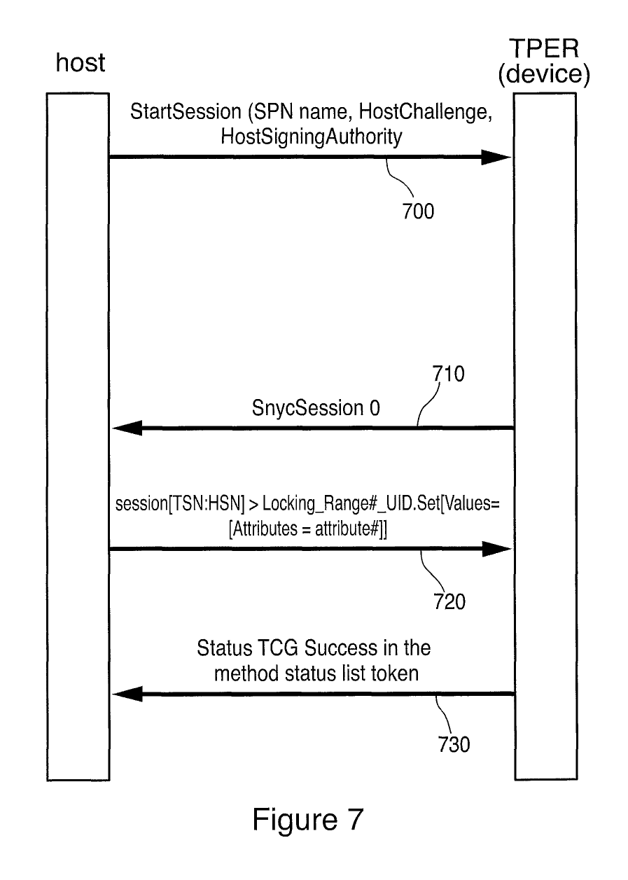

FIG. 7 is a flow diagram that illustrates the use of the communication packet of FIG. 6 to program attributes into the added column of the Locking SP table of FIG. 5. As shown in FIG. 6, the sub-packet is a compound of atoms as described in the TCG Opal standard. For example, the get command is specified as session[TSN:HSN]->Locking_Range#_UID.get [Cellblock: [startColumn=Attribute, end startColumn=Attribute]]. Writing an attribute is enabled by the TCG Opal set command: session[TSN:HSN]->Locking_Range#_UID.Set[Values =[Attributes=attribute#]] where HSN is Host Session Number, TSN is Trusted peripheral Session Number.

As shown in FIG. 7, the host device 50 first starts a session with the storage device 100, which is referred to in FIG. 7 as a “trusted peripheral” (TPER) (act 700). The storage device 100 retrieves the host device's signing authority, verifies the host challenge, and then calls a SyncSession method (act 710), which opens a secure session with the host device 50. The host device 50 then issues a “set” command using a communication packet including the ComID, the session number, and the DataPayload (the attribute value to be writing in the SP Locking table) (act 720). In response to the “set” command, the storage device 100 sets the attribute in the SP Locking table, in accordance with the data payload in the “set” command and sends an indication back to the host device 50 that the attribute programming was successful.

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A method for managing access to an addressable memory location in a storage device, the method comprising:
performing the following in a host device in communication with a storage device storing a table associating logical address ranges with an encryption key and read/write permissions:
sending a request to the storage device to add a column to the table; and
sending a request to the storage device to add an attribute to a cell of the added column to the table associated with a particular logical address range.

2. The method of claim 1, wherein the table is a Locking SP table of the Trusted Computing Group (TCG) Opal standard.

3. The method of claim 2, wherein the request to add a column to the table is a request to increase a “NumColumns” column of a “Locking” row of a pre-configuration table associated with the Locking SP table.

4. The method of claim 2, wherein the request to add an attribute is a TCG Opal set command.

5. The method of claim 4, wherein the TCG Opal set command is a part of a subpacket of a Serial Advanced Technology Attachment (SATA) command.

6. The method of claim 4, wherein the TCG Opal set command is a part of a subpacket of a Peripheral Component Interconnect (PCI) command.

7. The method of claim 1, wherein the attribute is a value.

8. The method of claim 1, wherein the attribute is a pointer to a table that stores the actual attribute value.

9. The method of claim 1, wherein the attribute specifies whether memory cells in the logical address range are single-level cells (SLC) or multi-level cells (MLC).

10. The method of claim 1, wherein the attribute specifies one or more of the following for the logical address range: power consumption characteristics, bandwidth consumption characteristics, data retention characteristics, endurance characteristics, random writes range characteristics, latency characteristics, and reliability characteristics for power failures.

11. A host device comprising:
an interface through which to communicate with a storage device storing a table associating logical address ranges with an encryption key and read/write permissions; and
a controller configured to:
send a request to the storage device to add a column to the table; and
send a request to the storage device to add an attribute to a cell of the added column to the table associated with a particular logical address range.

12. The host device of claim 11, wherein the table is a Locking SP table of the Trusted Computing Group (TCG) Opal standard.

13. The host device of claim 12, wherein the request to add a column to the table is a request to increase a “NumColumns” column of a “Locking” row of a pre-configuration table associated with the Locking SP table.

14. The host device of claim 12, wherein the request to add an attribute is a TCG Opal set command.

15. The host device of claim 14, wherein the TCG Opal set command is a part of a subpacket of a Serial Advanced Technology Attachment (SATA) command.

16. The host device of claim 14, wherein the TCG Opal set command is a part of a subpacket of a Peripheral Component Interconnect (PCI) command.

17. The host device of claim 11, wherein the attribute is a value.

18. The host device of claim 11, wherein the attribute is a pointer to a table that stores the actual attribute value.

19. The host device of claim 11, wherein the attribute specifies whether memory cells in the logical address range are single-level cells (SLC) or multi-level cells (MLC).

20. The host device of claim 11, wherein the attribute specifies one or more of the following for the logical address range: power consumption characteristics, bandwidth consumption characteristics, data retention characteristics, endurance characteristics, random writes range characteristics, latency characteristics, and reliability characteristics for power failures.
